(19) United States
(12) Patent Application Publication
(10) Pub. No.: US 2006/0116929 A1
(43) Pub. Date: Jun. 1, 2006

(54) On-line discount coupon

(76) Inventor: Martin Khang Nguyen, Westminster, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/001,097

(22) Filed: Dec. 1, 2004

(51) Int. Cl. G06Q 30/00

(52) U.S. Cl. 705/14

(57) ABSTRACT

An embodiment of the present invention includes a technique to provide discount coupons for on-line transactions. A discount agent interacts with a client having client information in an on-line transaction allowing the client to purchase a product having product information from a seller. A discount coupon associated with the product is provided. The discount coupon contains discount information for the product. Transaction information and the client information in the on-line transaction are forwarded to the seller. The transaction information includes at least one of payment information, shipping information, the discount information, and the product information.

### BACKGROUND

1. Field of the Invention

Embodiments of the invention relates to the field of marketing products, and more specifically, to discount coupons.

2. Description of Related Art

One main objective of product marketing is to provide merchandise information to consumers in an efficient manner. Merchandise information includes product highlights, promotional programs such as discount and rebates. Discount coupons or rebates are available to provide consumers reduced purchase prices. Discount coupons or rebates are a form of marketing devices to attract consumers to buy merchandises.

Existing techniques to provide merchandise information or on-line transactions, especially discount coupons or rebates, are typically inefficient and cumbersome. Most discount coupons or rebates are available in printed forms published in newspapers or magazines, or in advertisements. Many consumers do not read newspapers or magazines and therefore are not aware of the available discount coupons or rebates. Furthermore, printed coupons require the consumers to cut out the coupons and carry with them to the retailers. Consumers sometimes have to save several coupons and present them at the check-out stand, causing delay and inconvenience to other patrons. In addition, duplicates, copied, or fraudulent coupons may be presented, causing losses to the manufacturers.

### BRIEF DESCRIPTION OF THE DRAWINGS

Embodiments of the invention may best be understood by referring to the following description and accompanying drawings that are used to illustrate embodiments of the invention. In the drawings:

FIG. 1 is a diagram illustrating a system in which one embodiment of the invention can be practiced.

FIG. 2 is a diagram illustrating a discount agent according to one embodiment of the invention.

FIG. 3 is a diagram illustrating a database according to one embodiment of the invention.

FIG. 4 is a flowchart illustrating a process to provide discount for on-line transactions according to one embodiment of the invention.

FIG. 5 is a flowchart illustrating a process to interact with client according to one embodiment of the invention.

FIG. 6 is a diagram illustrating a computer system according to one embodiment of the invention.

### RELATED APPLICATIONS

The present application claims priority, as a continuation-in-part (CIP) application, of the following applications: (1) Title: “Discount Purchase Business Method”, filed Aug. 15, 2001, Ser. No. 09/931,677, (2) Title: “Internet Related Discount Coupon Rebate Business Method”, filed Aug. 2, 2002, Ser. No. 10/211,386, (3) Title “Coupon Rebate Business Method Using Portable Personal Communication Devices”, filed Jun. 12, 2003, Ser. No. 10/461,556, and (4) Title “Discount Coupon Usage”, filed Sep. 29, 2004, Ser. No. 10/953,009, the contents of which are hereby incorporated by reference in their entirety.

### DESCRIPTION

An embodiment of the present invention includes a technique to provide discount coupons for on-line transactions. A discount agent interacts with a client having client information in an on-line transaction allowing the client to purchase a product having product information from a seller. A discount coupon associated with the product is provided. The discount coupon contains discount information for the product. Transaction information and the client information in the on-line transaction are forwarded to the seller. The transaction information includes at least one of payment information, shipping information, the discount information, and the product information.

In the following description, numerous specific details are set forth. However, it is understood that embodiments of the invention may be practiced without these specific details. In other instances, well-known circuits, structures, and techniques have not been shown in order not to obscure the understanding of this description.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a subprogram, a subroutine, a method of manufacturing or fabrication, etc. When a process corresponds to a function, its termination corresponds to a return of the function to the calling function or the main function.

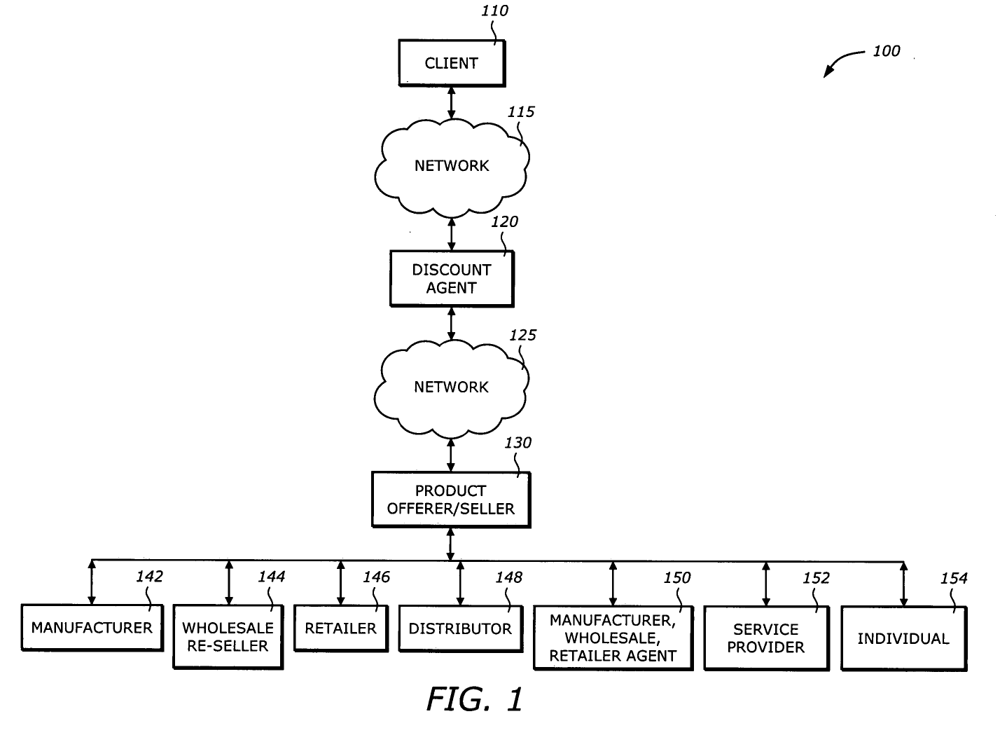

FIG. 1 is a diagram illustrating a system 100 in which one embodiment of the invention can be practiced. The system 100 includes a client 110, networks 115 and 125, a discount agent 120, and a product offerer/ seller 130.

The client 110 is a user of the discount agent 120. The client 110 may be a consumer, an individual, an entity, a business, a client application, a program, a computer, a network node, a cellular phone, a personal digital assistant (PDA), a notebook computer, a laptop computer, a workstation, a palm computer, an interface module, etc. Typically, the client 110 connects to the discount agent 120 through the network 115 to carry out an on-line transaction. The on-line transaction may be any transaction that involves a buyer and a seller, an offerer and an offeree, a sender and a recipient, etc. The connection between the client 110 and the discount agent 120 may be wired or wireless. A wireless connection may be through radio frequency (RF) such as hotspot, Bluetooth, optical methods such as infra-red, and sonic transmissions such as ultrasound, etc.

The networks 115 and 125 may be the same or different. They may be any one of a local area network (LAN), a wide area network (WAN), an Internet, an intranet, an extranet, etc.

The discount agent 120 is an agent that provides discount coupons or information for the products purchases by the client 110 in an on-line transaction. The products may include physical items (e.g., grocery items, equipment, tangible products), a service (e.g., health providing service, legal service, financial service), or a transaction. The discount agent 120 acts as an agent, a liaison, a promoter, or an intermediary between the client 110 and the offerer/seller 130. Typically, the discount agent 120 represents the product or products offerer/seller to provide product information and discount coupons or services to the client 110. The discount agent 120 may be represented as a host application, a link, a Website in the world wide web, a remote log-in platform, etc.

The product offerer/seller 130 may be a seller, an individual, an entity, a business establishment, a host application, etc. The product offerer/seller 130 may be any one of a manufacturer 142, a wholesale reseller 144, a retailer 146, a distributor 148, an agent 150 for a manufacturer, a wholesale reseller, or a retailer, a service provider 152, and an individual 154. The manufacturer 142 is the manufacturer of the product offered for sale to the client 110. The wholesale reseller 144 is a reseller of the products for one or more manufacturers. The retailer 146 is a reseller of the products to the consumers. The distributor 148 distributes the products to the consumers. The agent 150 is a representative of the manufacturer, wholesale reseller, retailer, or distributor. The service provider 152 is an individual, a business entity that provides services to the consumers including the client 110. Examples of the service provider 152 are professional individuals such as doctors, dentists, lawyers, accountants, etc., government agencies including federal, state, and local agencies, business entities such as real estate agents, car rental businesses, food providers, etc. Any on-line transactions may be provided. The individual 154 is anybody who sells or offers for sales a product or products having a discount.

The business model of the system is as follows. The discount agent 120 and the product offerer/seller 130 have an agreement that allows the discount agent 120 to promote the products offered by the offerer/seller 130 in exchange for a fee. The product promotion may be in any form that provides product information together with discount coupons. The discount coupons are managed by the discount agent 120. Depending on the products or the agreement, the fee to be charged for an on-line transaction may vary. The client 110 may be directed to the discount agent 120 through another link or directly. The client 110 may log on a Website representing the discount agent 120 and carry out the on-line transaction as managed and controlled by the discount agent 120. The on-line transaction may include a purchase of a product, a product inquiry, a transaction, etc. Typically, the on-line transaction includes transactions such as providing client information; selecting a product category, a product, a discount, a method of payment, a method of shipping, etc.; reviewing transactions; updating databases; providing payment information, billing information, shipping information, and discount information; processing payments; redirecting to another link; forwarding transaction information, etc.

The advantages of the system 100 include:

Convenience: The client 110 can carry out the on-line transaction in a convenient manner at home or office without the need of actual visits to the seller's facilities. In addition, the client 110 can access the discount agent 120 from any place that has wireless connections and get instant discount coupon.

Availability of a wealth of information: The client 110 may access a vast amount of product and discount information from a variety of product offerers or sellers.

Efficiency: The on-line transaction provides a complete one-stop shopping experience to the client 110, including product selection and ordering, price comparison, discount selection, etc.

Flexibility: The client 110 may have flexibility to use the discount coupon. He or she can select the discount coupon at the time of ordering on-line, or to print out the discount coupon and present it at the time of purchase at the physical store.

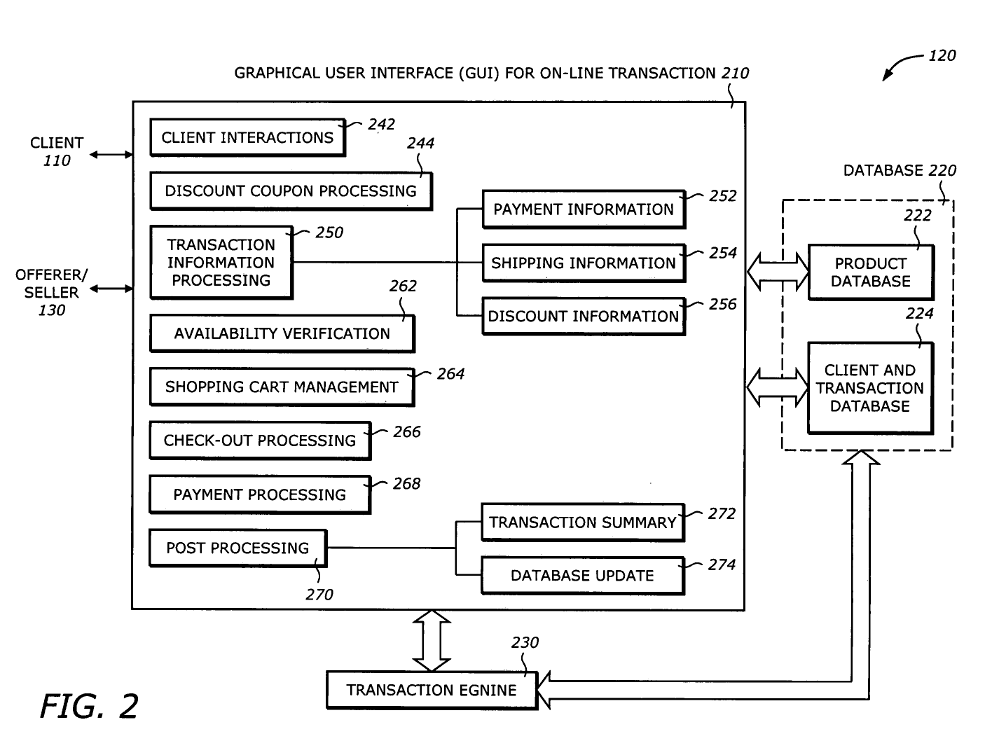

FIG. 2 is a diagram illustrating the discount agent 120 according to one embodiment of the invention. The discount agent 120 includes a graphical user interface (GUI) 210 for the on-line transaction, a database 220, and a transaction engine 230.

The GUI 210 provides an efficient and convenient user interface to allow the client 110 to complete the on-line transaction. It allows the client 110 to navigate through a series of pages according to the selection in an informative manner. It includes modules or methods that perform a specified task. The modules or methods include: a client interaction module 242, a discount coupon processing module 244, a transaction information processing module 250, an availability verification module 262, a shopping cart management module 264, a check-out processing module 266, a payment processing module 268, and a post processing module 270. It also has interface modules to interface to the database 220 and the transaction engine 230.

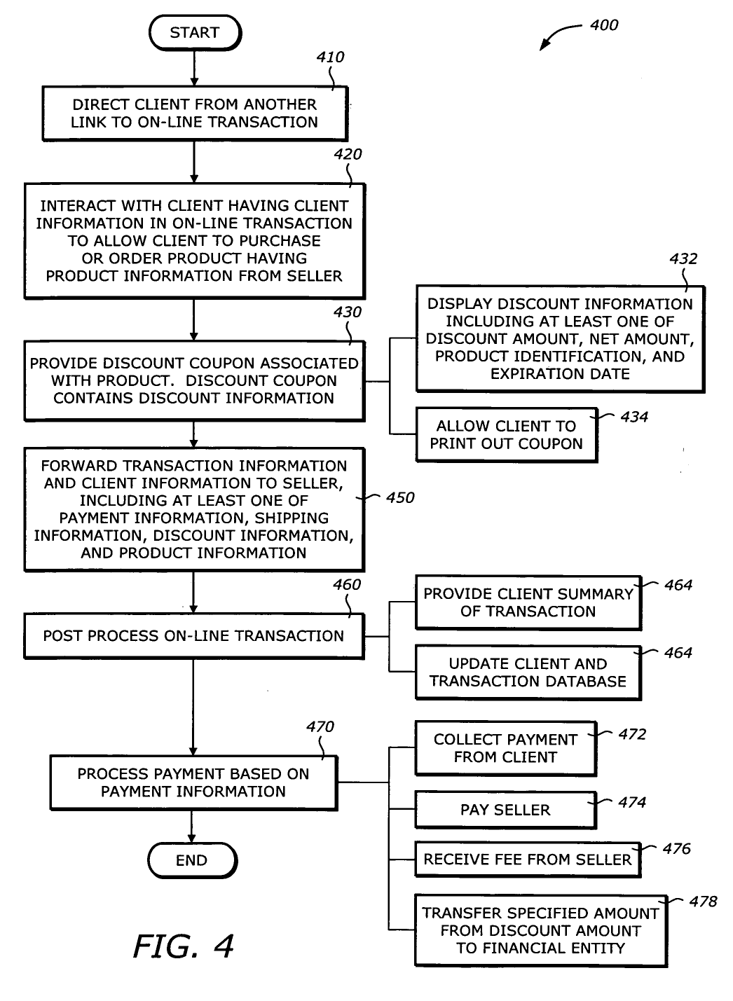

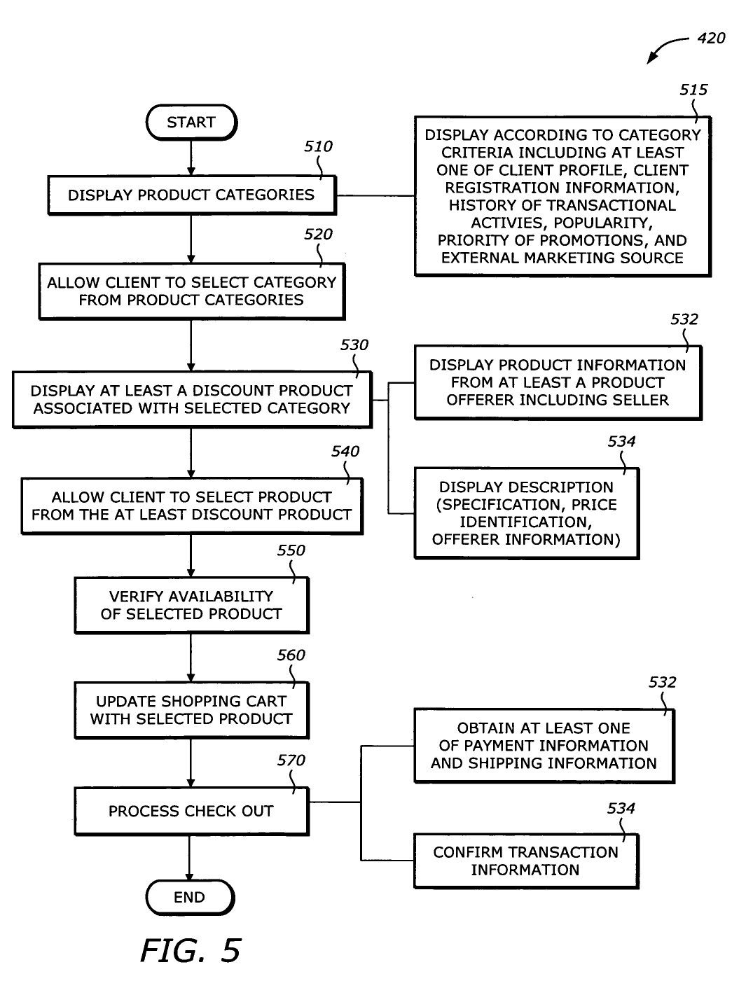

The modules included in the GUI 210 perform operations or tasks as described in FIGS. 4 and 5. For example, the client interaction module 242 performs the operation in Block 420 of FIG. 4. Each of these modules may also include one or more modules or methods to perform specified tasks.

The database 220 is a repository or storage of data or information organized in a manner that can be accessed and manipulated by the GUI 210 and the transaction engine 230. It is updated as frequently as necessary. It includes a product database 222 and a client and transaction database 224. The product database 222 includes information on the products that are offered with discount information. Typically, the information is provided by the offerer/seller 130 or by the transaction engine 230. The client and transaction database 224 includes information on the clients or users of the system and the transactions completed by the clients. This information can be used in a number of ways. In one way, it can be used to update or create the client profile and/or preferences to provide a customized on-line transaction for the client each time he or she logs on the discount agent 120. In another way, it can be used to gather statistics or usage pattern of the consumers so that marketing information can be compiled and used by the product offerers or sellers.

The transaction engine 230 interacts with the GUI 210 and the database 220 to perform inferences, logical deductions, decisions, analyses of data, compilations, etc. based on the information provided by the client 110. The transaction engine 210 may be optional if these tasks are embedded within the GUI 210 or the database 220. For example, one task done by the transaction engine 230 is to prioritize clients. At one particular time, there may be several clients logging on the system at the same time and ordering the same product. The transaction engine 230 may have to prioritize the clients according to some criteria if the availability of the product or the discount coupons is limited. Another example of a task performed by the transaction engine 230 is to infer the client profile based on the history of transactional activities.

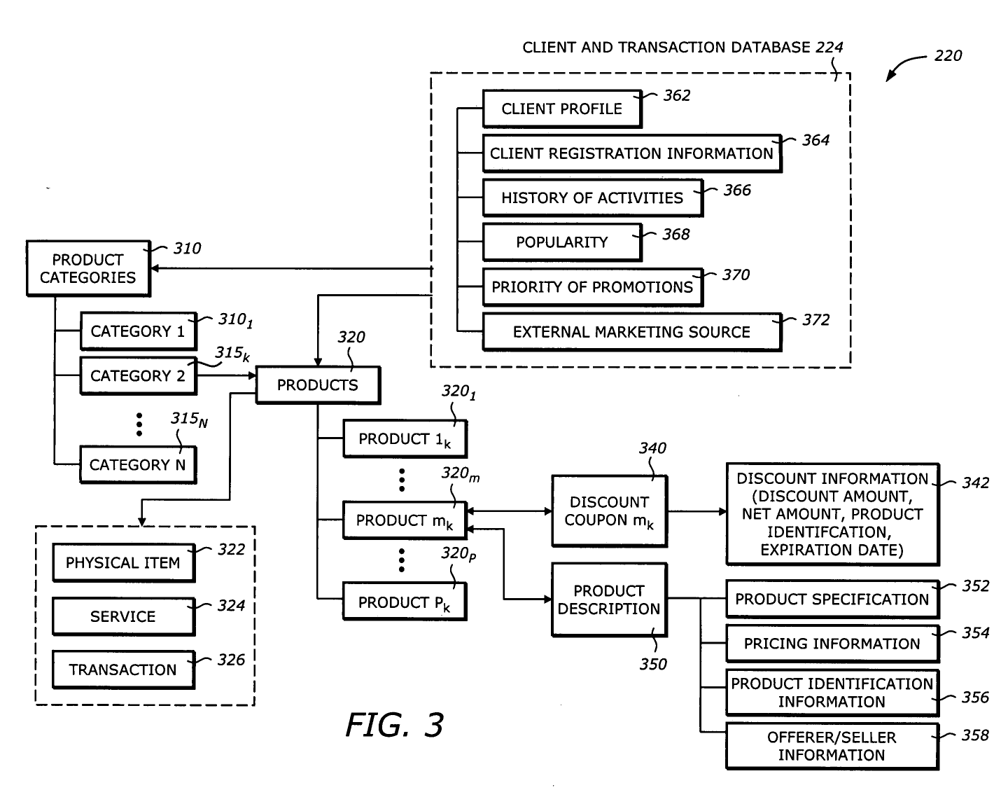

FIG. 3 is a diagram illustrating the database 220 according to one embodiment of the invention. The database 220 includes the product database 222 and the client and transaction database 224. The product database 222 provides information on the products and the discounts. The client and transaction database 224 provides information on the client and the transaction.

The product database 222 includes product categories 310. The product categories 310 include N categories 315₁ to 315_{N} of the products offered by the offerer/seller 130. Examples of the categories may include personal hygiene, health, food, entertainment, finance, computers, media equipment, cameras, stationeries, grocery items, etc. The product categories 310 may be organized hierarchically including sub-categories and sub-sub-categories, etc. For example, under personal hygiene category, there may be sub-categories such as toothpaste, toothbrush, deodorants, etc.

Each category or sub-category 315k includes listings of products 320 belonging to the categories or sub-categories. The products 320 includes a listing of P products 320₁ to 320_{P}. A product 320ₘ in the products 320₁ or 320_{P} may have a discount coupon 340 and a product description 350. Not all the products 320₁ and 320_{P} have a discount coupon. For example, discount coupons may be used up for a particular product. The products 320 may be a physical item 322, a service 324, or a transaction 326. The physical item 322 is any tangible item such as groceries, equipment, etc. The service 324 is a service provided by the offerer/seller such as a doctor's visit, a car rental, etc. The transaction 326 is a transaction made between the client 110 and the product offerer/seller 130 such as an agreement to enter a survey, a registration for a membership, an application for a loan, etc.

The discount coupon 340 includes discount information 342. The discount information 342 includes at least one of a discount amount, a net amount for the product, a product identification, and an expiration date. The discount amount may include a fixed amount or a percentage. It may also be a rebate amount that the client 110 has to fill in information and send back to the seller to receive a rebate. The net amount is the amount to pay for the product after the discount is applied. The product identification identifies the product that the discount is associated with. This could be a specific product name or a model number. The expiration date is the date or the period beyond which the discount becomes invalid, null, or canceled.

The product description 350 describes the product 320. It may include at least one of product specification 352, pricing information 354, product identification 356, and offerer/seller information 358. The product specification 352 provides information about the product 320. The pricing information 354 includes the price or the suggested sale price before the discount. The product identification 356 identifies the product 320. The offerer/seller information 358 provides information on the offerer or seller of the product 320.

The client and transaction database 224 includes a client profile 362, client registration information 364, history of transactional activities 366, category or product popularity 368, priority of promotions 370, and an external marketing source 372. The client profile 362 includes profile of the client such as product interests and preferences, frequency of shopping, demographic information, etc. The client registration information 364 includes information provided by the client when the client registers to the discount agent such as membership information, product interests and preferences, etc. The history of transactional activities 366 includes the past transactional activities of the client. The popularity 368 includes the rankings of categories or products that are popular among the clients that use the discount agent. The priority of promotions 370 include the priority ranking of the products or categories based on promotional efforts. For example, a new product offered by the offerer/seller may have a high priority of promotion. The external marketing source 372 may include statistics or product rankings obtained from another marketing source such as data mining, data warehousing, etc.

The client and transaction database 224 provide category or product criteria to the product categories 310 or the products 320. The GUI 210 displays the categories or the products using these criteria. For example, if the client 110 has a history of ordering health products in the past, then when the client 110 logs on, the GUI displays the health category at the top.

FIG. 4 is a flowchart illustrating a process 400 to provide discount for on-line transactions according to one embodiment of the invention. This flowchart illustrates operations or tasks performed by the modules shown in FIG. 2.

Upon START, the process 400 directs the client from another link to the on-line transaction of the discount agent (Block 410). This operation may be optional because the client may log on to the discount agent directly without being redirected from another source. This operation is typically performed when the client logged onto another system, such as a Website of a retailer, and is redirected to the discount agent when he or she selects a product that has a discount coupon offered by the discount agent. Next, the process 400 interacts with the client in the on-line transaction to allow the client to purchase or order a product from a seller (Block 420). This operation corresponds to the client interaction module 242 in FIG. 2.

Then, the process 400 provides a discount coupon associated with the product (Block 430). The discount coupon contains discount information. This operation corresponds to the discount coupon processing module 244 (FIG. 2) and includes displaying discount information including at least one of a discount amount, the net amount, a product identification, and an expiration date (Block 432); and allowing the client to print out the discount coupon (Block 434).

Next, the process 400 forwards the transaction information and client information on the on-line transaction to the seller (Block 450). This operation corresponds to the transaction information processing module 250 (FIG. 2) The transaction information includes at least one of payment information, billing information, discount information, and product information. Then, the process 400 post processes the on-line transaction (Block 460). The post processing operation corresponds to the post processing module 270 (FIG. 2) and may include at least one of the following: providing a summary of the on-line transaction to the client (Block 462), and updating the client and transaction database (Block 464). The summary of the on-line transaction may include the receipt of the order, the ordered product or products, the discount amount, the net amount, the total amount, the billing and shipping information.

Next, the process 400 may process the payment based on the payment information (Block 470). This operation corresponds to the payment processing module 268 (FIG. 2) and is performed when the discount agent is authorized to receive payment directly from the client and to re-pay the offerer/seller later, or to process the discount based on the client instructions. This operation may include: collecting payment from the client (Block 472), paying the offerer/seller (Block 474), and receiving the fee from the offerer/seller (Block 476). If instructed by the client, the operation 470 may transfer a specified amount from the discount amount to a financial entity (Block 478). The financial entity may be any one of an investment service provider, a stock service provider, a mutual fund provider, a banking service provider, a trust fund, and a financial management service provider. The process 400 is then terminated.

FIG. 5 is a flowchart illustrating the process 420 to interact with client according to one embodiment of the invention.

Upon START, the process 420 displays the product categories (Block 510). This operation includes displaying the product categories according to some category criteria including at least one of client profile, client registration information, history of transactional activities, category popularity, priority of promotions, and external marketing source.

Next, the process 420 allows the client to select a category from the product categories (Block 520). Then, the process 420 displays at least a discount product associated with the selected category (Block 530). This operation may include: displaying the product information from at least a product offerer including the seller (Block 532), and displaying the product description including product specification, pricing information, product identification, and offerer information (Block 534).

Next, the process 420 allows the client to select the product from the at least discount product (Block 540). Then, the process 420 verifies the availability of the selected product (Block 550). This operation corresponds to the availability verification module 262 (FIG. 2). If the product is not available, the process 420 informs the client so that the client can select another product or another category. Otherwise, the process 420 updates the shopping cart with the selected product (Block 560). This operation corresponds to the shopping cart management module 264 (FIG. 2).

Next, the process 420 processes check-out (Block 570). This operation corresponds to the check-out processing module 266 (FIG. 2) and may be performed by: obtaining at least one of payment information and shipping information (Block 572), and confirming the transaction information (Block 574). Any errors or corrections can then be performed. The process 420 is then terminated.

Elements of one embodiment of the invention may be implemented by hardware, firmware, software or any combination thereof. When implemented in software, the elements of an embodiment of the present invention are essentially the code segments to perform the necessary tasks. The software may include the actual code to carry out the operations described in one embodiment of the invention, or code that emulates or simulates the operations. The program or code segments can be stored in a processor or machine accessible medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the processor readable medium include an electronic circuit, a semiconductor memory device, a read only memory (ROM), a flash memory, an erasable ROM (EROM), a floppy diskette, a compact disk (CD) ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include data that, when accessed by a machine, cause the machine to perform the operations described above. The term “data” here refers to any type of information that is encoded for machine-readable purposes. Therefore, it may include program, code, data, file, etc.

All or part of an embodiment of the invention may be implemented by software. The software may have several modules coupled to one another. A software module is coupled to another module to receive variables, parameters, arguments, pointers, etc. and/or to generate or pass results, updated variables, pointers, etc. A software module may also be a software driver or interface to interact with the operating system running on the platform. A software module may also be a hardware driver to configure, set up, initialize, send and receive data to and from a hardware device.

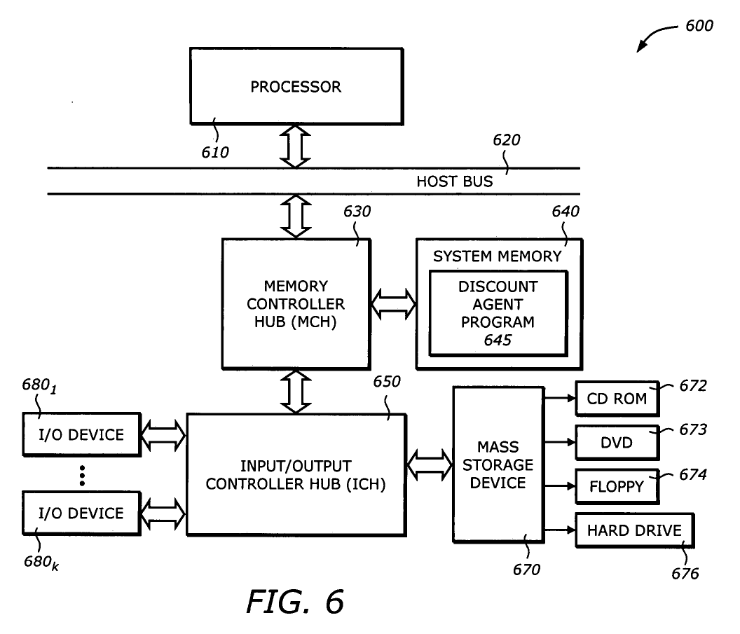

FIG. 6 is a diagram illustrating a computer system 600 according to one embodiment of the invention. The system 600 may be a server that connects to the networks 115 and 125 to implement the functionalities of the discount agent 120 shown in FIG. 1. It includes a host processor 610, a host bus 620, a memory control hub (MCH) 630, a system memory 640, an input/output control hub (ICH) 650, a mass storage device 670, and input/output devices 680₁ to 680_{K}. Note that the system 600 may include more or less elements than these elements.

The host processor 610 represents a central processing unit of any type of architecture, such as embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The host bus 620 provides interface signals to allow the processor 610 to communicate with other processors or devices, e.g., the MCH 630. The host bus 620 may support a uni-processor or multiprocessor configuration. The host bus 620 may be parallel, sequential, pipelined, asynchronous, synchronous, or any combination thereof.

The MCH 630 provides control and configuration of memory and input/output devices such as the system memory 640 and the ICH 650. The MCH 630 may be integrated into a chipset that integrates multiple functionalities such as the isolated execution mode, host-to-peripheral bus interface, memory control. The MCH 630 interfaces to a peripheral bus. For clarity, not all the peripheral buses are shown. It is contemplated that the system 600 may also include peripheral buses such as Peripheral Component Interconnect (PCI), accelerated graphics port (AGP), Industry Standard Architecture (ISA) bus, and Universal Serial Bus (USB), etc.

The system memory 640 stores system code and data. The system memory 640 is typically implemented with dynamic random access memory (DRAM) or static random access memory (SRAM). The system memory may include program code or code segments implementing one embodiment of the invention. The system memory includes the discount agent program 645 that implements the functionalities of the discount agent 120 shown in FIG. 1. Any one of the elements of the discount agent program 645 may be implemented by hardware, software, firmware, microcode, or any combination thereof. The system memory 640 may also include other programs or data which are not shown, such as an operating system.

The ICH 650 has a number of functionalities that are designed to support I/O functions. The ICH 650 may also be integrated into a chipset together or separate from the MCH 630 to perform I/O functions. The ICH 650 may include a number of interface and I/O functions such as PCI bus interface to interface to the peripheral bus 155, processor interface, interrupt controller, direct memory access (DMA) controller, power management logic, timer, system management bus (SMBus), universal serial bus (USB) interface, mass storage interface, low pin count (LPC) interface, etc.

The mass storage device 670 stores archive information such as code, programs, files, data, applications, and operating systems. The mass storage device 670 may include compact disk (CD) ROM 672, a digital video/versatile disc (DVD) 673, floppy drive 674, and hard drive 676, and any other magnetic or optic storage devices. The mass storage device 670 provides a mechanism to read machine-accessible media. The machine-accessible media may contain computer readable program code to perform tasks as described above.

The I/O devices 680₁ to 680_{K} may include any I/O devices to perform I/O functions. Examples of I/O devices 680₁ to 680_{K} include controller for input devices (e.g., keyboard, mouse, trackball, pointing device), media card (e.g., audio, video, graphics), network card, and any other peripheral controllers.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
interacting with a client having client information in an on-line transaction to allow the client to purchase or order a product having product information from a seller;
providing a discount coupon associated with the product, the discount coupon containing discount information for the product; and
forwarding transaction information and the client information in the on-line transaction to the seller, the transaction information including at least one of payment information, shipping information, the discount information, and the product information.

2. The method of claim 1 wherein interacting comprises:
displaying product categories;
allowing the client to select a category from the product categories;
displaying at least a discount product associated with the selected category; and
allowing the client to select the product from the at least discount product.

3. The method of claim 2 further comprising:
verifying availability of the selected product;
updating a shopping cart with the selected product; and
processing check-out.

4. The method of claim 3 wherein processing check-out comprises:
obtaining at least one of the payment information and the shipping information from the client;
confirming the transaction information.

5. The method of claim 2 wherein displaying product categories comprises:
displaying product categories according to category criteria including at least one of client profile, client registration information, history of transactional activities, popularity, priority of promotions, and an external marketing source.

6. The method of claim 2 wherein displaying the at least discount product comprises:
displaying product information from at least a product offerer including the seller.

7. The method of claim 6 wherein displaying the product information comprises:
displaying description of the products, the description including product specification, pricing information, product identification information, and offerer information.

8. The method of claim 2 wherein providing the discount coupon comprises:
displaying the discount information for the product, the discount information including at least one of a discount amount, a net amount, a product identification, and an expiration date.

9. The method of claim 2 wherein providing the discount coupon comprises:
allowing the client to print out the coupon.

10. The method of claim 1 further comprising:
directing the client to the on-line transaction from another link.

11. The method of claim 1 further comprising:
providing the client a summary of the on-line transaction.

12. The method of claim 1 further comprising:
updating a database including the transaction information and the client information.

13. The method of claim 1 wherein the seller is one of a manufacturer, a whole sale re-seller, a retailer, a distributor, a manufacturer agent, a wholesale agent, a retailer agent, and a service provider.

14. The method of claim 1 wherein the product is one of a physical item, a service, and a transaction.

15. The method of claim 1 further comprising:
processing payment based on the payment information.

16. The method of claim 15 wherein processing the payment comprises:
collecting the payment from the client; and
paying the seller.

17. The method of claim 15 wherein processing the payment comprising:
transferring a specified amount from a discount amount in the discount coupon to a financial entity including one of an investment service provider, a stock service provider, a mutual fund provider, a banking service provider, a trust fund, and a financial management service provider.

18. The method of claim 16 further comprising:
receiving a fee from the seller.

19. The method of claim 1 wherein interacting with the client comprises:
interacting via one of wired and wireless connections.

20. The method of claim 1 wherein forwarding the transaction information comprises:
sending the transaction information to the seller so that the seller ships the product directly to the client and receives payment from the client using the transaction information.

21. A graphical user interface (GUI) comprising:
a client interaction module to interact with a client having client information in an on-line transaction to allow the client to purchase or order a product having product information from a seller;
a discount coupon processing module coupled to the client interaction module to provide a discount coupon associated with the product, the discount coupon containing discount information for the product; and
a transaction information processing module coupled to the client interaction module to forward transaction information and the client information in the on-line transaction to the seller, the transaction information including at least one of payment information, shipping information, the discount information, and the product information.

22. The GUI of claim 21 wherein the client interacting module comprises:
a module to display product categories;
a module to allow the client to select a category from the product categories;
a module to display at least a discount product associated with the selected category; and
a module to allow the client to select the product from the at least discount product.

23. The GUI of claim 22 further comprising:
an availability verification module to verify availability of the selected product;
a shopping cart management module to update a shopping cart with the selected product; and
a check-out processing module to process check-out.

24. The GUI of claim 23 wherein the check-out processing module comprises:
a module to obtain at least one of the payment information and the shipping information from the client; and
a module to confirm the transaction information.

25. The GUI of claim 22 wherein the module to display product categories comprises:
a module to display product categories according to category criteria including at least one of client profile, client registration information, history of transactional activities, popularity, priority of promotions, and an external marketing source.

26. The GUI of claim 22 wherein the module to display the at least discount product comprises:
a module to display product information from at least a product offerer including the seller.

27. The GUI of claim 26 wherein the module to display the product information comprises:
a module to display description of the products, the description including product specification, pricing information, product identification information, and offerer information.

28. The GUI of claim 22 wherein the module to provide the discount coupon comprises:
a module to display the discount information for the product, the discount information including at least one of a discount amount, a net amount, a product identification, and an expiration date.

29. The GUI of claim 22 wherein the module to provide the discount coupon comprises:
a module to allow the client to print out the coupon.

30. The GUI of claim 21 further comprising:
a module to direct the client to the on-line transaction from another link.

31. The GUI of claim 21 further comprising:
a module to provide the client a summary of the on-line transaction.

32. The GUI of claim 21 further comprising:
a module to update a database including the transaction information and the client information.

33. The GUI of claim 21 wherein the seller is one of a manufacturer, a whole sale re-seller, a retailer, a distributor, a manufacturer agent, a wholesale agent, a retailer agent, and a service provider.

34. The GUI of claim 21 wherein the product is one of a physical item, a service, and a transaction.

35. The GUI of claim 21 further comprising:
a payment processing module to process payment based on the payment information.

36. The GUI of claim 35 wherein the payment processing module comprises:
a module to collect the payment from the client; and
a module to pay the seller.

37. The GUI of claim 35 wherein the payment processing module comprises:
a module to transfer a specified amount from a discount amount in the discount coupon to a financial entity including one of an investment service provider, a stock service provider, a mutual fund provider, a banking service provider, a trust fund, and a financial management service provider.

38. The GUI of claim 36 further comprising:
a module to receive a fee from the seller.

39. The GUI of claim 21 wherein the client interacting module comprises:
a module to interact via one of wired and wireless connections.

40. The GUI of claim 21 wherein the transaction information processing module comprises:
a module to send the transaction information to the seller so that the seller ships the product directly to the client and receives payment from the client using the transaction information.

41. An article of manufacture comprising:
a machine-accessible medium including data that, when accessed by a machine, causes the machine to perform operations comprising:
interacting with a client having client information in an on-line transaction to allow the client to purchase or order a product having product information from a seller;
providing a discount coupon associated with the product, the discount coupon containing discount information for the product; and
forwarding transaction information and the client information in the on-line transaction to the seller, the transaction information including at least one of payment information, shipping information, the discount information, and the product information.

42. The article of manufacture of claim 41 wherein the data causing the machine to perform interacting comprises data that, when accessed by the machine, causes the machine to perform operations comprising:
displaying product categories;
allowing the client to select a category from the product categories;
displaying at least a discount product associated with the selected category; and
allowing the client to select the product from the at least discount product.

43. The article of manufacture of claim 42 wherein the data further comprises data that, when accessed by the machine, causes the machine to perform operations comprising:
verifying availability of the selected product;
updating a shopping cart with the selected product; and
processing check-out.

44. The article of manufacture of claim 43 wherein the data causing the machine to perform processing check-out comprises data that, when accessed by the machine, causes the machine to perform operations comprising:
obtaining at least one of the payment information and the shipping information from the client;
confirming the transaction information.

45. The article of manufacture of claim 42 wherein the data causing the machine to perform displaying product categories comprises data that, when accessed by the machine, causes the machine to perform operations comprising:
displaying product categories according to category criteria including at least one of client profile, client registration information, history of transactional activities, popularity, priority of promotions, and an external marketing source.

46. The article of manufacture of claim 42 wherein the data causing the machine to perform displaying the at least discount product comprises data that, when accessed by the machine, causes the machine to perform operations comprising:
displaying product information from at least a product offerer including the seller.

47. The article of manufacture of claim 46 wherein the data causing the machine to perform displaying the product information comprises data that, when accessed by the machine, causes the machine to perform operations comprising:
displaying description of the products, the description including product specification, pricing information, product identification information, and offerer information.

48. The article of manufacture of claim 42 wherein the data causing the machine to perform providing the discount coupon comprises data that, when accessed by the machine, causes the machine to perform operations comprising:
displaying the discount information for the product, the discount information including at least one of a discount amount, a net amount, a product identification, and an expiration date.

49. The article of manufacture of claim 42 wherein the data causing the machine to perform providing the discount coupon comprises data that, when accessed by the machine, causes the machine to perform operations comprising:
allowing the client to print out the coupon.

50. The article of manufacture of claim 41 wherein the data further comprises data that, when accessed by the machine, causes the machine to perform operations comprising:
directing the client to the on-line transaction from another link.

51. The article of manufacture of claim 41 wherein the data further comprises data that, when accessed by the machine, causes the machine to perform operations comprising:
providing the client a summary of the on-line transaction.

52. The article of manufacture of claim 41 wherein the data further comprises data that, when accessed by the machine, causes the machine to perform operations comprising:
updating a database including the transaction information and the client information.

53. The article of manufacture of claim 41 wherein the seller is one of a manufacturer, a whole sale re-seller, a retailer, a distributor, a manufacturer agent, a wholesale agent, a retailer agent, and a service provider.

54. The article of manufacture of claim 41 wherein the product is one of a physical item, a service, and a transaction.

55. The article of manufacture of claim 41 wherein the data further comprises data that, when accessed by the machine, causes the machine to perform operations comprising:
processing payment based on the payment information.

56. The article of manufacture of claim 55 wherein the data causing the machine to perform processing the payment comprises data that, when accessed by the machine, causes the machine to perform operations comprising:
collecting the payment from the client; and
paying the seller.

57. The article of manufacture of claim 55 wherein the data causing the machine to perform processing the payment comprising data that, when accessed by the machine, causes the machine to perform operations comprising:
transferring a specified amount from a discount amount in the discount coupon to a financial entity including one of an investment service provider, a stock service provider, a mutual fund provider, a banking service provider, a trust fund, and a financial management service provider.

58. The article of manufacture of claim 56 wherein the data further comprises data that, when accessed by the machine, causes the machine to perform operations comprising:
receiving a fee from the seller.

59. The article of manufacture of claim 41 wherein the data causing the machine to perform interacting with the client comprises data that, when accessed by the machine, causes the machine to perform operations comprising:
interacting via one of wired and wireless connections.

60. The article of manufacture of claim 41 wherein the data causing the machine to perform forwarding the transaction information comprises data that, when accessed by the machine, causes the machine to perform operations comprising:
sending the transaction information to the seller so that the seller ships the product directly to the client and receives payment from the client using the transaction information.

61. A system comprising:
a client;
a seller; and
a discount agent coupled to the client and the seller via a network, the discount agent having a graphical user interface (GUI), the GUI comprising:
a client interaction module to interact with the client having client information in an on-line transaction to allow the client to purchase or order a product having product information from the seller;
a discount coupon processing module coupled to the client interaction module to provide a discount coupon associated with the product, the discount coupon containing discount information for the product; and
a transaction information processing module coupled to the client interaction module to forward transaction information and the client information in the on-line transaction to the seller, the transaction information including at least one of payment information, shipping information, the discount information, and the product information.
